(19) United States
(12) Patent Application Publication
(10) Pub. No.: US 2026/0121198 A1
(43) Pub. Date: Apr. 30, 2026

(54) BATTERY PACK

(71) Applicant: TOYOTA JIDOSHA KABUSHIKI KAISHA, Toyota-shi (JP)

(72) Inventors: Shinichiro MORI, Nisshin-shi (JP); Soichiro NAKAMURA, Toyota-shi (JP); Tristan PATRICK SEXTON, Nagoya-shi (JP)

(73) Assignee: TOYOTA JIDOSHA KABUSHIKI KAISHA, Toyota-shi (JP)

(21) Appl. No.: 19/248,954

(22) Filed: Jun. 25, 2025

(30) Foreign Application Priority Data
Sep. 26, 2024 (JP) 2024-167818

(51) Int. Cl. H01M 50/262; H01M 10/613

(52) U.S. Cl. CPC H01M 50/262; H01M 10/613

(57) ABSTRACT

The battery pack includes a battery module, a current collector plate joined to the battery module via a conductive adhesive, and a positioning pin attached to a lower face of the battery module and inserted into a hole provided in the current collector plate to position the battery module with respect to the current collector plate, wherein the positioning pin satisfies Expression (1) when F₀ is the weight of the battery module, R is the reaction force of the conductive adhesive, θ is the angle of the positioning pin, and is the friction coefficient.

### CROSS-REFERENCE TO RELATED APPLICATION

This application claims priority to Japanese Patent Application No. 2024-167818 filed on Sep. 26, 2024. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

Japanese Unexamined Patent Application Publication No. 2015-028939 (JP 2015-028939 A) discloses a positioning pin for positioning an electrical connection terminal.

### SUMMARY

When a battery module and a current collector plate (cooler) are stacked, for example, they are joined using a conductive adhesive. A metal filler, for example, is added to this conductive adhesive, and accordingly viscosity thereof is particularly high before curing. Therefore, in order to smoothly insert the positioning pin into a hole that is provided in the current collector plate, for example, the angle of the positioning pin needs to be an acute angle. However, it is necessary to lengthen the positioning pin in order to do so. As a result, the structure of the battery pack may become complicated and enlarged.

The present disclosure provides a battery pack that enables smoothly inserting a positioning pin and reliably positioning a battery module with respect to a current collector plate, without complicating and enlarging the structure.

A battery pack according to the present disclosure includes
a battery module,
a current collector plate that is joined to the battery module via a conductive adhesive, and
a positioning pin that is attached to a lower face of the battery module and inserted into a hole that is provided in the current collector plate so as to position the battery module with respect to the current collector plate, in which
the positioning pin is shaped so as to satisfy Expression (1) below:

$$\begin{matrix}( Expression 1 ) & \\ ( {F}_{0} - R ) sin θ > μ ( {F}_{0} - R ) cos θ & ( 1 )\end{matrix}$$

where F₀ is weight of the battery module, R is reactive force of the conductive adhesive, θ is angle of the positioning pin, and is frictional coefficient.

According to the present disclosure, forming the positioning pin into a shape that satisfies a predetermined relational expression enables the positioning pin to be smoothly inserted without complicating or enlarging the structure, even when a highly viscous conductive adhesive is used for joining the battery module and the current collector plate. Also, the battery module can be reliably positioned with respect to the current collector plate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a positioning pin in a battery pack according to an embodiment;

FIG. 2 is a graph for explaining the relationship between the thickness L of the conductive adhesive and the reaction force R in the battery pack according to the embodiment;

FIG. 3 is a diagram for explaining a relation between an angle of a positioning pin and a force acting on a current collector plate in the battery pack according to the embodiment; and

FIG. 4 is a diagram illustrating a schematic configuration of a modification of the positioning pin in the battery pack according to the embodiment.

### DETAILED DESCRIPTION OF EMBODIMENTS

A battery pack according to an embodiment of the present disclosure will be described with reference to the drawings. Incidentally, the constituent elements in the following embodiments include those that can be easily replaced by a person skilled in the art or those that are substantially the same.

The battery pack according to the embodiment is used as a battery of vehicles such as hybrid electric vehicle (HEV: Hybrid Electric Vehicle), plug-in hybrid electric vehicle (PHEV: Plug-in Hybrid Electric Vehicle), battery electric vehicle (BEV: Battery Electric Vehicle).

As shown in FIG. 1, the battery pack according to the embodiment includes a battery module 1, a conductive adhesive 2, a current collector plate (cooler) 3, and a positioning pin 4. In FIG. 1, only the configuration necessary for realizing the battery pack according to the embodiment is shown as an excerpt, and other configurations are not shown.

The battery module 1 includes a plurality of battery cells. The battery cell is, for example, a secondary battery such as a lithium-ion battery. In the case where the battery cell is composed of a lithium ion battery, the battery cell may be either a liquid-based battery or an all-solid-state battery.

The conductive adhesive 2 is used to join the battery module 1 and the current collector plate 3. For example, a metal filler is added to the conductive adhesive 2.

The current collector plate 3 also functions as a cooler, and is constituted by, for example, a lower case that accommodates each member of the battery pack. The current collector plate 3 is bonded to the battery module 1 via a conductive adhesive 2. Further, the current collector plate 3 is provided with a hole portion 31 for inserting the positioning pin 4. The diameter of the hole portion 31 is larger than the diameter of the positioning pin 4.

The positioning pin 4 is attached to the lower face of the battery module 1. Further, the positioning pin 4 is inserted into the hole portion 31 provided in the current collector plate 3 to position the battery module 1 with respect to the current collector plate 3. Further, the positioning pin 4 has a configuration satisfying Expression (1) below, where F₀ is the weight of the battery module 1, R is the reaction force of the conductive adhesive 2, θ is the angle of the positioning pin 4, and is the frictional coefficient.

$$\begin{matrix}( Mathematical formula 2 ) & \\ ( {F}_{0} - R ) sin θ > μ ( {F}_{0} - R ) cos θ & ( 1 )\end{matrix}$$

As shown in FIG. 1, θ in the above formula (1) specifically indicates the angle of the lower portion (tapered portion) of the positioning pin 4 with respect to the upper surface of the current collector plate 3. The lower portion of the positioning pin 4 is, for example, a cone shape as a whole, and the angle of the cone is θ.

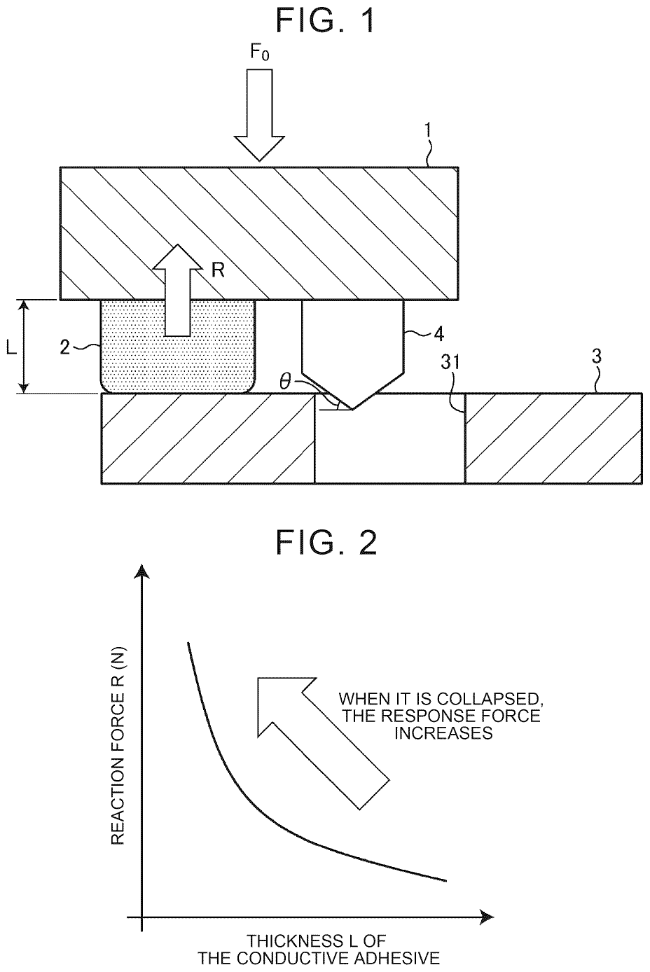

Here, when the battery module is mounted on the current collector plate, the conductive adhesive applied between the two is mounted while being crushed by the battery module, but the viscosity of the uncured conductive adhesive is particularly high. Further, as shown in FIG. 2, the thickness L of the conductive adhesive and the reaction force R are inversely proportional to each other, and the reaction force increases as the conductive adhesive collapses.

Therefore, in order to reliably insert the positioning pin of the battery module into the hole portion of the current collector plate, it is necessary to make the positioning pin long and steep the angle (taper angle) of the lower portion. However, if the positioning pin is lengthened, the structure of the battery pack may become complicated and large.

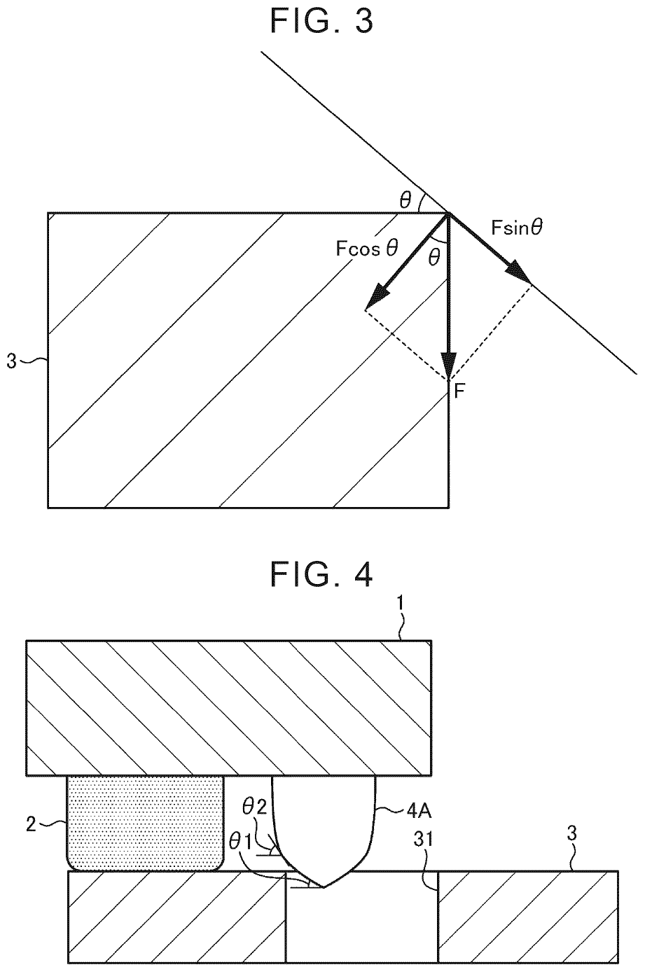

Therefore, in the battery pack according to the embodiment, for example, as shown in FIG. 3, in consideration of the relationship between the angle of the positioning pin 4 and the force acting on the current collector plate 3, the positioning pin 4 is shaped so as to satisfy the above formula (1). Thus, even when the highly viscous conductive adhesive 2 is used for bonding the battery module 1 and the current collector plate 3, the positioning pin 4 can be smoothly inserted without increasing the overall structure. Further, it is possible to reliably position the battery module 1 with respect to the current collector plate 3.

### Modification

Here, the shape of the lower portion of the positioning pin 4 shown in FIG. 1 has a straight tapered shape when viewed from the side, but the shape of the lower portion of the positioning pin 4 is not limited thereto. For example, as shown in FIG. 4, a positioning pin 4A having a mortar-shaped lower portion may be used.

The lower portion of the positioning pin 4A is formed in a curved shape, and the current collector plate 3 is not angularly fixed. That is, in the lower portion of the positioning pin 4A, the angle (the angle formed by the tangent to the surface of the current collector plate 3) is θ1. In the lower portion of the positioning pin 4A, the angle above the front end (the angle formed by the tangent to the surface of the current collector plate 3) is θ2.

Angles θ1 and θ2 are set so as to satisfy the relationship of the above expression (1) when θ is replaced with θ1 and θ2, respectively. The angles θ1 and θ2 are set to “θ1<θ2”. That is, the angle θ2 on the upper side of the distal end is set to be larger than the angle θ1 on the distal end side of the lower portion of the positioning pin 4A. In other words, the lower portion of the positioning pin 4A is set to gradually increase from the distal end side to the upper portion.

In the bonding between the battery module 1 and the current collector plate 3, when the positioning pin 4A starts to be inserted into the hole portion 31, the thickness L of the conductive adhesive 2 is still large, and the reaction force R of the conductive adhesive 2 is also small (see FIG. 2). In other words, since the resistivity of the conductive adhesive 2 is small, the angle θ1 at the lower end of the positioning pin 4A is made shallow (small). On the other hand, as the positioning pin 4A enters the hole portion 31, the thickness L of the conductive adhesive 2 decreases, and the reaction force R of the conductive adhesive 2 also increases (see FIG. 2). That is, since the resistivity of the conductive adhesive 2 increases, the angle θ2 above the lower end of the positioning pin 4A is made deeper (larger) than the angle θ1.

As described above, the lower portion of the positioning pin 4A is formed into a mortar shape, so that the positioning pin moves so as to slide along the edge of the hole portion 31, although it is difficult to move laterally in the early stage of inserting the positioning pin into the hole portion 31. In addition, the end of insertion into the hole portion 31 is easy to move laterally and is a sliding movement along the edge of the hole portion 31. Therefore, the length of the positioning pin 4A can be further shortened by forming the lower portion of the positioning pin 4A in the form of a mortar.

Further advantages and variations can be readily derived by one of ordinary skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A battery pack comprising:
a battery module;
a current collector plate that is joined to the battery module via a conductive adhesive; and
a positioning pin that is attached to a lower face of the battery module and inserted into a hole that is provided in the current collector plate so as to position the battery module with respect to the current collector plate, wherein
the positioning pin is shaped so as to satisfy Expression (1) below:
$$\begin{matrix}( Expression 1 ) & \\ ( {F}_{0} - R ) sin θ > μ ( {F}_{0} - R ) cos θ & ( 1 )\end{matrix}$$
where F₀ is weight of the battery module, R is reactive force of the conductive adhesive, θ is angle of the positioning pin, and μ is frictional coefficient.
